(19) United States
(12) Patent Application Publication
(10) Pub. No.: US 2023/0237182 A1
(43) Pub. Date: Jul. 27, 2023

(54) INCIDENT MANAGEMENT APPARATUS AND INCIDENT MANAGEMENT METHOD

(71) Applicant: HITACHI, LTD., Tokyo (JP)

(72) Inventors: Hiroshi NASU, Tokyo (JP); Takashi TAMESHIGE, Tokyo (JP)

(73) Assignee: HITACHI, LTD., Tokyo (JP)

(21) Appl. No.: 17/942,521

(22) Filed: Sep. 12, 2022

(30) Foreign Application Priority Data
Jan. 24, 2022 (JP) 2022-008869

(51) Int. Cl. G06F 21/62

(52) U.S. Cl. CPC G06F 21/6218

(57) ABSTRACT

An incident management server includes: a failure information receiving unit configured to receive, from a server device that stores a plurality of resources and manages access to each resource based on access authority management information that is information including information of a user who can access each of the resources, information of a failure that has occurred in any of the plurality of resources; an access authority information specifying unit configured to specify a user who accesses a resource in which the failure has occurred in the server device and an access authority of the user when information of the failure is received; and an access authority management information setting unit configured to set information of the specified user and access authority in the access authority management information.

### CROSS-REFERENCE TO RELATED APPLICATION

This application claims priority pursuant to Japanese patent application No. 2022-008869, filed on Jan. 24, 2022, the entire disclosure of which is incorporated herein by reference.

### BACKGROUND OF THE INVENTION

### 1. Field of the Invention

The present invention relates to an incident management apparatus and an incident management method.

### 2. Description of the Related Art

Cloud services for lending computer resources on the Internet are provided by various business operators. It is required to enable deployment and operation of an application in an arbitrary cloud system or on-premises environment in accordance with a request of a customer, a storage location of data held by the customer, or the like.

In an application execution environment such as Kubernetes, a handling situation to a failure occurring in a resource of an application is generally managed by an incident management system as an incident. In this case, it is essential to manage an appropriate access authority to the resource for ensuring the safety of the application for the user (failure handling user) in charge of recovery work from the occurred failure.

For example, JP 2011-210190 A discloses a technique in which, in a failure monitoring system, a monitoring server acquires operation information from a monitoring target system, and when it is determined that a failure has occurred, the monitoring server notifies the occurrence of the failure, a dynamic authority management server that has received the failure occurrence notification specifies a person in charge of work registered for the failure occurrence server, and instructs an authentication management server to validate the specified user ID, and a dynamic authority management server that has received a failure recovery notification instructs an authentication management server to invalidate the temporarily validated user ID for the failure occurrence server. “Redmine” ([online], [searched on Nov. 26, 2021], Internet) and “ServiceNow” ([online], [searched on Nov. 26, 2021], Internet) disclose business management services.

### SUMMARY OF THE INVENTION

In the techniques disclosed in the management systems or management services of JP 2011-210190 A, “Redmine” ([online], [searched on Nov. 26, 2021], Internet), “ServiceNow” ([online], [searched on Nov. 26, 2021], Internet), when setting the access authority to the resource, it is necessary to match the content of the access authority of the resource of the current application with the latest information of the failure handling user. However, in a case where disagreement between the two pieces of information frequently occurs, both pieces of information need to be monitored at all times, and thus the management cost of the access authority increases.

The present invention has been made in view of such a current situation, and an object thereof is to provide an incident management apparatus and an incident management method capable of setting an appropriate access authority necessary for recovery of an occurred failure of a resource.

One aspect of the present invention for solving the above problem is an incident management apparatus that has a processor and a memory, including: a failure information receiving unit configured to receive, from a server device that stores a plurality of resources and manages access to each resource based on access authority management information that is information including information of a user who can access each of the resources, information of a failure that has occurred in any of the plurality of resources; an access authority information specifying unit configured to specify a user who accesses a resource in which the failure has occurred in the server device and an access authority of the user when information of the failure is received; and an access authority management information setting unit configured to set information of the specified user and access authority in the access authority management information.

One aspect of the present invention to solve the above problem is an incident management method for causing an information processing device to execute: failure information receiving processing of receiving, from a server device that stores a plurality of resources and manages access to each resource based on access authority management information that is information including information of a user who can access each of the resources, information of a failure that has occurred in any of the plurality of resources; access authority management information setting processing of specifying a user who accesses a resource in which the failure has occurred in the server device and an access authority of the user when information of the failure is received; and setting information of the specified user and access authority in the access authority management information.

According to the present invention, information necessary for recovery of a failure of a generated resource can be set in a timely manner.

Objects, configurations, and effects besides the above description will be apparent through the explanation on the following embodiments.

### BRIEF DESCRIPTION OF THE DRAWINGS

FIG. 1 is a diagram for explaining an outline of a configuration of an incident management system 1 and processing performed by the incident management system according to the present embodiment;

FIG. 2 is a diagram illustrating an example of a user table;

FIG. 3 is a diagram illustrating an example of a role table;

FIG. 4 is a diagram illustrating an example of an application execution base table;

FIG. 5 is a diagram illustrating an example of a log table;

FIG. 6 is a diagram illustrating an example of an incident table;

FIG. 7 is a diagram illustrating an example of a resource manager table;

FIG. 8 is a diagram illustrating an example of a hardware configuration included in each information processing device;

FIG. 9 is a flowchart for explaining an example of incident information addition processing;

FIG. 10 is a flowchart for explaining an example of access authority management information acquisition processing;

FIG. 11 is a flowchart for explaining an example of incident information update processing;

FIG. 12 is a flowchart for explaining an example of access authority management information update processing; and

FIG. 13 is a diagram illustrating an example of an incident management screen.

### DESCRIPTION OF THE PREFERRED EMBODIMENTS

Hereinafter, an embodiment of the present invention will be described with reference to the drawings.

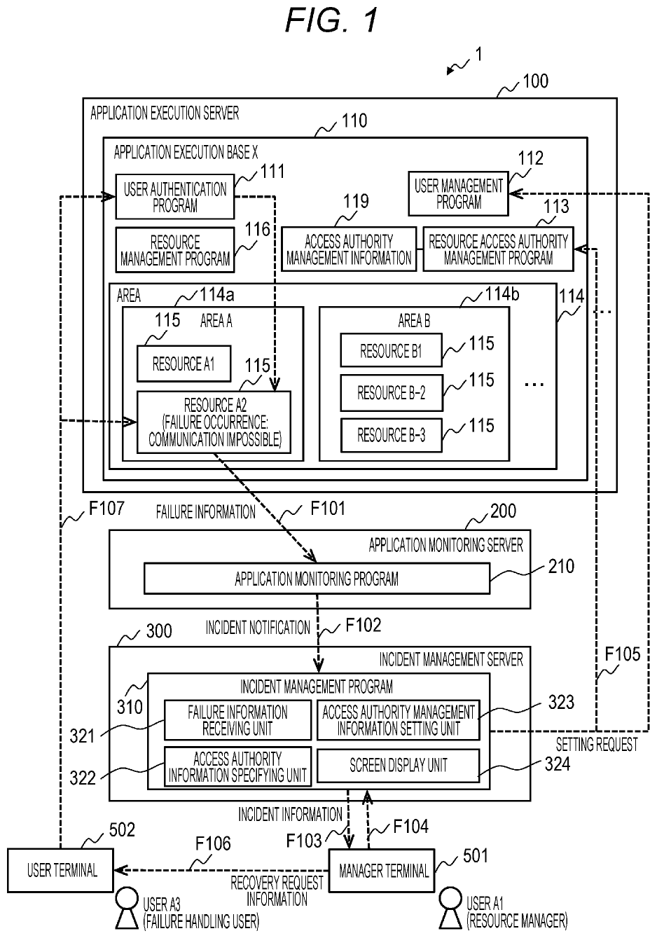

FIG. 1 is a diagram for explaining an outline of a configuration of an incident management system 1 and processing performed by the incident management system 1 according to the present embodiment.

<Configuration>

The incident management system 1 includes an application execution server 100, an application monitoring server 200, an incident management server 300, a manager terminal 501, and a user terminal 502. Between them, for example, they are communicably connected by a wired or wireless communication network such as the Internet, a local area network (LAN), a wide area network (WAN), or a dedicated line.

The application execution server 100 is an information processing device that executes various applications by an application execution base 110 described later.

The application monitoring server 200 is an information processing device that monitors the operation of each application of the application execution base 110 and the occurrence of a failure.

The incident management server 300 is an information processing device that supports a response to a failure (hereinafter, referred to as an incident) of the application detected by the application monitoring server 200.

The manager terminal 501 is an information processing device used by a manager who manages the incident management system 1. In the present embodiment, it is assumed that the manager exists for each resource 115 to be described later that stores an application (hereinafter, each manager is referred to as a resource manager). The resource manager has all access authorities for the resource. A plurality of the manager terminals 501 may be provided for each resource manager.

The user terminal 502 is an information processing device used by each user (hereinafter, referred to as a user in charge) in charge of recovery work from a failure that has occurred in the application execution base 110. Each user in charge accesses the application execution server 100 by using the user terminal 502, thereby performing coping with a failure, recovery, and the like. A plurality of the user terminals 502 may be provided for each user in charge.

Next, the application execution server 100 stores one or a plurality of application execution bases 110. The application execution base 110 is, for example, Kubernetes. The application execution base 110 is a program that performs operation of a resource of an application stored in a resource area 114, management of a resource, management of a resource manager and a user in charge, management of access authority to a resource, and the like.

Specifically, the application execution base 110 includes a user authentication program 111 that authenticates a user in charge of accessing the application execution base 110, a user management program 112 that creates, updates, and deletes account information of the user in charge and a resource manager (hereinafter, the user in charge and the resource manager are collectively referred to as “user”), a resource access authority management program 113 that manages access authority to the resource area 114, the resource area 114, and a resource management program 116 that manages a configuration of the resource area 114.

The resource area 114 includes one or a plurality of storage areas (hereinafter, also referred to as a namespace). Each namespace (resource areas 114a, 114b, . . . ) has one or more resources 115 that are units for storing and executing an application. That is, the resource 115 is a unit of a storage area such as a container, a service, or a virtual machine.

The resource access authority management program 113 manages access authority management information 119 which is information of a user in charge who can access each resource 115 of the resource area 114. In a case where each user accesses, each program of the resource 115 determines whether execution is possible on the basis of the access authority management information 119, and executes the program in a case where it is determined that execution is possible.

In the present embodiment, the access authority management information 119 includes information of a user ID of each user, a resource accessible by the user, and specific contents (writing, reference, etc.) of an access authority to the resource, but information other than these pieces of information may be included.

The resource management program 116 receives a predetermined operation command for the resource 115 from the user in charge (user terminal 502) or the resource manager (manager terminal 501), and causes the resource 115 to execute various processes.

Next, the application execution server 100 stores a user table and a role table described below, and manages the access authority of each user to a resource. The user table and the role table are referred to, for example, when the user authentication program 111 is executed.

(User Table)

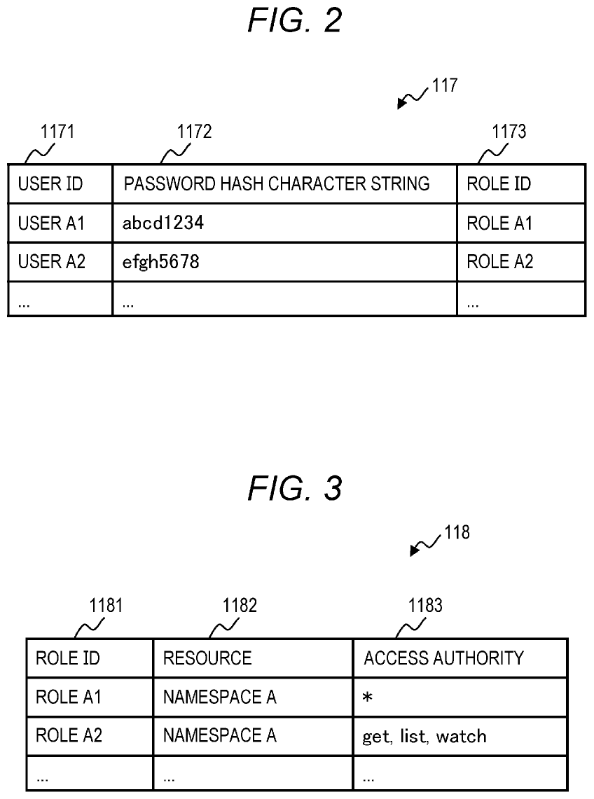

FIG. 2 is a diagram illustrating an example of a user table 117. The user table 117 includes a plurality of records, and each record includes data items of a user ID 1171 in which an ID of each user is set, a password hash character string 1172 in which information of a character string obtained by hashing a password of the user is set, and a role ID 1173 in which information of an access authority (role) to the resource 115 allocated to the user is set. The specific content of the role is defined in the following role table 118.

(Role Table)

FIG. 3 is a diagram illustrating an example of the role table 118. The role table 118 includes a plurality of records, and each record includes data items of a role ID 1181 in which an ID of a role is set, a resource 1182 in which information of a resource targeted by the role is set, and an access authority 1183 in which information of specific content of an access authority to the resource is set.

In the example of the drawing, in a “role A1” and a “role A2”, all resources included in the “namespace A” are targets of the access authority setting. The “role A1” has all access authorities for each resource (“*”). The “role A2” has only authority to refer to resources (“get, list, watch”).

Next, as illustrated in FIG. 1, the application monitoring server 200 includes an application monitoring program 210. The application monitoring program 210 monitors a resource state of an application running on the application execution base 110.

The incident management server 300 includes an incident management program 310. The incident management program 310 executes creation, update, deletion, and the like of information regarding the incident. The incident management program 310 creates information of a user who accesses the application execution base 110. The incident management program 310 calls the resource access authority management program 113, and sets or updates the access authority management information 119.

Specifically, the incident management program 310 includes a failure information receiving unit 321, an access authority information specifying unit 322, an access authority management information setting unit 323, and a screen display unit 324.

The failure information receiving unit 321 receives failure information (failure information) occurred in any one of the resources 115 from the application execution base 110 that manages access to each resource 115 based on the access authority management information 119.

The access authority information specifying unit 322 specifies a user (failure handling user) who accesses the resource 115 in which the failure has occurred in the application execution base 110 and an access authority of the failure handling user.

The access authority management information setting unit 323 sets information of the failure handling user and the access authority specified by the access authority information specifying unit 322 in the access authority management information 119.

The screen display unit 324 displays various types of information such as the incident and the access authority management information 119 on the screen.

Further, the incident management server 300 stores databases of an application execution base table, a log table, an incident table, and a resource manager table to be described below.

(Application Execution Base Table)

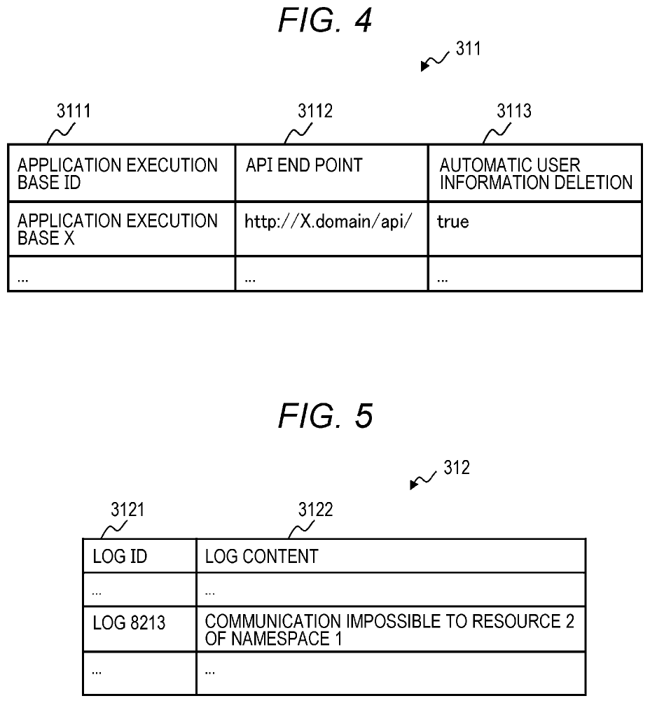

FIG. 4 is a diagram illustrating an example of an application execution base table 311. The application execution base table 311 has one or a plurality of records. Each record includes data items of an application execution base ID 3111 in which an ID of each application execution base 110 accessed by the incident management program 310 is set, an API end point 3112 in which information (for example, URL) of an end point of a program (for example, the resource access authority management program 113 provided as an API: Application Programming Interface) that manages the access authority management information 119 of the application execution base 110 is set, and an automatic user information deletion 3113.

In the automatic user information deletion 3113, information indicating whether to delete the information of the failure handling user in the access authority management information 119 of the application execution base 110 when the recovery of the resource 115 by the failure handling user is completed is set. In the present embodiment, in a case where the automatic user information deletion is “true”, the information of the failure handling user is deleted, and in a case where the automatic user information deletion 3113 is “false”, the information of the failure handling user is not deleted.

(Log Table)

FIG. 5 is a diagram illustrating an example of a log table 312. The log table 312 has one or a plurality of records. Each record includes data items of a log ID 3121, which is transmitted from the application monitoring program 210 and is recorded with an ID of log information in which content of an incident (failure) is set, and a log content 3122 in which content (text information of a log file or the like) of the log information transmitted from the application monitoring program 210 is stored.

The log information includes, for example, information of a resource in which a failure has occurred, a failure type, a resource type, or another resource related to the resource.

(Incident Table)

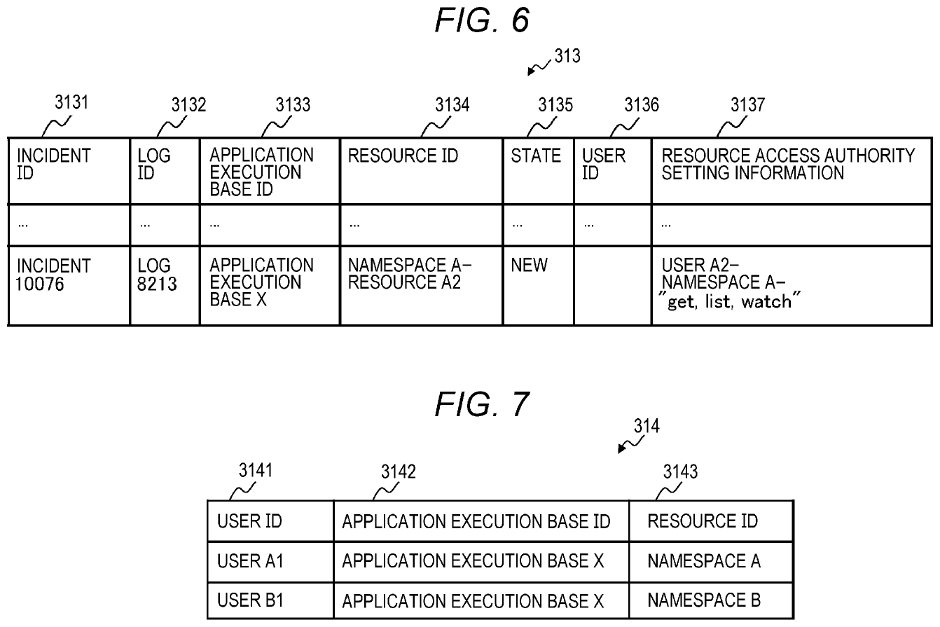

FIG. 6 is a diagram illustrating an example of an incident table 313. The incident table 313 can be created by the resource manager inputting data through an incident management screen 315 to be described later.

The incident table 313 has one or a plurality of records. Each record has each data item of an incident ID 3131 in which the ID of an incident is set, a log ID 3132 in which the ID of the log information in which the information of the incident is recorded is set, an application execution base ID 3133 in which the ID of the application execution base 110 in which the incident has occurred is set, a resource ID 3134 in which the ID of the resource in which the incident has occurred is set, a state 3135 in which the information (hereinafter, referred to as state information) on the current handling situation by the failure handling user in charge of the recovery work of the incident is set, a user ID 3136 in which the user ID of the failure handling user is set, and a resource access authority setting information 3137 in which the information (hereinafter, referred to as access authority information) indicating the content of the access authority to be set for the resource related to the incident is set. Although not illustrated in the drawing, date and time information is set in each record.

In the state 3135, “new” is automatically set when a record is created (when an incident is detected). Thereafter, in a case where the failure handling user corresponding to the incident is determined (or in a case where the failure handling user has been changed), the resource manager (the manager terminal 501) sets “in process” in the state 3135. Thereafter, in a case where the handling by the failure handling user is completed, the resource manager (the manager terminal 501) sets “completed” in the state 3135. The setting of “in process” or “completed” to the state 3135 may be automatically performed when the incident management program 310 detects the determination of the failure handling user or the completion of handling of the fault.

In a case where information is not set to the user ID 3136 at the time of creating a record (at the time of detecting an incident), but thereafter, the failure handling user is determined (or changed), the resource manager (the manager terminal 501) sets the ID of the failure handling user in the state 3135. The incident management program 310 may detect the determination or change of the failure handling user and automatically set the ID of the failure handling user.

In the resource access authority setting information 3137, for example, the user ID of the failure handling user, the resource ID of the resource in which the incident occurs, and information (get, list, watch, etc.) on the access authority to the resource are stored.

(Resource Manager Table)

FIG. 7 is a diagram illustrating an example of a resource manager table 314. The resource manager table 314 includes a plurality of records, and each record includes data items of a user ID 3141 in which a user ID of a resource manager is set, an application execution base ID 3142 in which an ID of an application execution base 110 in charge of the resource manager is set, and a resource ID 3143 in which an ID of a resource in charge of the resource manager is set.

<Outline of Processing>

Next, an outline of processing performed by the incident management system 1 will be described. As illustrated in FIG. 1, first, the application monitoring program 210 of the application monitoring server 200 receives, from the application execution server 100, information (hereinafter, referred to as failure information) on a failure occurring in the resource 115 (application) detected by the application execution server 100 (F101).

On the basis of the received failure information, the application monitoring server 200 transmits an incident notification for notifying the failure as an incident to the incident management server 300, and the incident management program 310 of the incident management server 300 receives the incident notification (F102).

On the basis of the received incident notification, the incident management program 310 creates information (hereinafter, referred to as incident information) for requesting recovery of a failure. The incident management program 310 transmits the created incident information to the manager terminal 501 (F103). Thereafter, the resource manager of the manager terminal 501 performs a task of specifying an appropriate failure handling user on the basis of the indentation information received by the manager terminal 501. The manager terminal 501 transmits information of the failure handling user specified by the resource manager to the incident management server 300 (F104). The manager terminal 501 may detect the failure handling user's specification and automatically transmit the information of the failure handling user to the incident management server 300.

The incident management program 310 transmits request information (hereinafter, referred to as a setting request) including information regarding the specified failure handling user and the access authority thereof to the application execution base 110 (F105). The user management program 112 and the resource access authority management program 113 of the application execution base 110 set information such as a failure handling user, a resource, and an access authority in the access authority management information 119 based on the received setting request.

Further, the incident management program 310 transmits information (hereinafter, referred to as recovery request information) requesting a response such as recovery of a failure to the user terminal 502 managed by the specified failure handling user (F106).

Upon receiving the recovery request information, the user terminal 502 displays the contents thereof on the screen, whereby the failure handling user recognizes the necessity of the recovery work of the failure. Then, the user terminal 502 logs in to the application execution base 110 through the authentication of the user authentication program 111 by the operation of the failure handling user. The user terminal 502 transmits an operation command for the resource 115 (the access authority to the resource 115 is set in the access authority management information 119 by F105) in which the incident has occurred to the resource management program 116 (F107). The resource management program 116 performs an operation on the resource 115 according to the received operation command. As a result, the failure in the failure occurrence resource is eliminated, and the recovery work is completed.

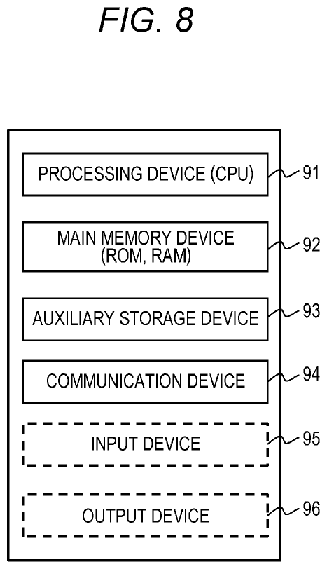

Here, FIG. 8 is a diagram illustrating an example of a hardware configuration included in each information processing device of the application execution server 100, the application monitoring server 200, the incident management server 300, the manager terminal 501, and the user terminal 502. Each information processing device includes a processing device 91 (processor) such as a central processing unit (CPU), a digital signal processor (DSP), a graphics processing unit (GPU), or a field-programmable gate array (FPGA), a main memory device 92 (memory) such as a read only memory (ROM) or a random access memory (RAM), an auxiliary storage device 93 such as a hard disk drive (HDD) or a solid state drive (SSD), and a communication device 94 that is a communication interface corresponding to one or more communication standards (for example, IEEE 802.3). Each information processing device may include an input device 95 including a mouse, a keyboard, or the like, or an output device 96 including a liquid crystal display, an organic electro-luminescence (EL) display, or the like.

Each function of each information processing device is implemented by the processing device 91 reading and executing a program stored in the main memory device 92 or the auxiliary storage device 93. This program can be recorded on a recording medium and distributed, for example. Each information processing device may be realized by a field programmable gate array (FPGA) that is a rewritable logic circuit or an application specific integrated circuit (ASIC) that is an application specific integrated circuit, instead of the combination of the processing device 91 and the main memory device 92. Each information processing device may be realized by a combination of different configurations, for example, a combination of a CPU, a ROM, a RAM, and an FPGA, instead of the combination of the processing device 91 and the main memory device 92.

Next, details of processing performed by the incident management server 300 will be described.

<Incident Information Addition Processing>

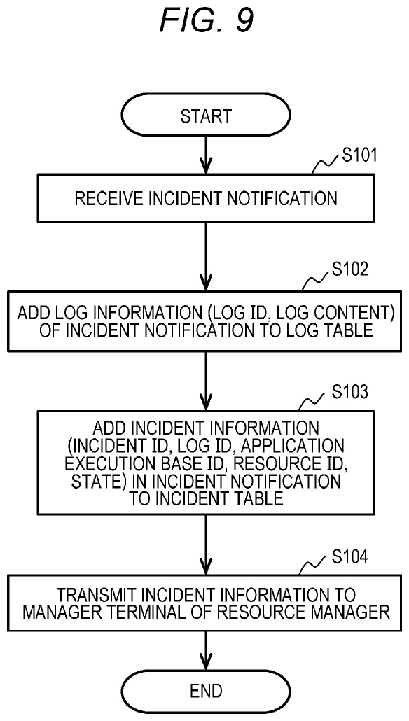

FIG. 9 is a flowchart for explaining an example of incident information addition processing. The incident information addition processing is a process of receiving an incident notification from the application monitoring server 200 (F102) and registering the information in the incident table 313. The incident information addition processing is repeatedly executed after the activation of the incident management server 300, for example.

The incident management program 310 of the incident management server 300 waits for reception of the incident notification including the failure information from the application monitoring server 200. The failure information includes, for example, an application execution base ID of the application execution base 110 in which the failure has occurred, a resource ID, and a log of the failure.

When the incident notification is received (S101), the incident management program 310 registers the content of the received incident notification in the log table 312 (S102). For example, the incident management program 310 registers the content of the log in the incident notification in a new record in which a new log ID is set in the log table 312.

The incident management program 310 registers the content of the received incident notification in the incident table 313 (S103). For example, the incident management program 310 sets the log ID, the application execution base ID in the incident notification, and the resource ID in a new record in which a new incident ID is set in the incident table 313. The incident management program 310 sets “new” in the state 3135 of the record.

The incident management program 310 specifies the user ID of the resource manager of the resource (hereinafter, referred to as a failure occurrence resource) related to the failure (hereinafter, referred to as occurrence incident) indicated by the incident notification by referring to the resource manager table 314. The incident management program 310 transmits information regarding the incident to the manager terminal 501 related to the specified resource manager (S104).

For example, the incident management program 310 refers to the resource manager table 314, specifies a record in which information corresponding to the application execution base ID and the resource ID in the incident notification is set in the application execution base ID 3142 and the resource ID 3143, and acquires the content of the user ID 3141 of the record. The incident management program 310 transmits the information (Incident ID, log ID, application execution base ID, resource ID, and state information) set in S103 to the email address of the resource manager related to the acquired user ID 3141. The incident information addition processing ends as described above.

<Access Authority Management Information Acquisition Processing>

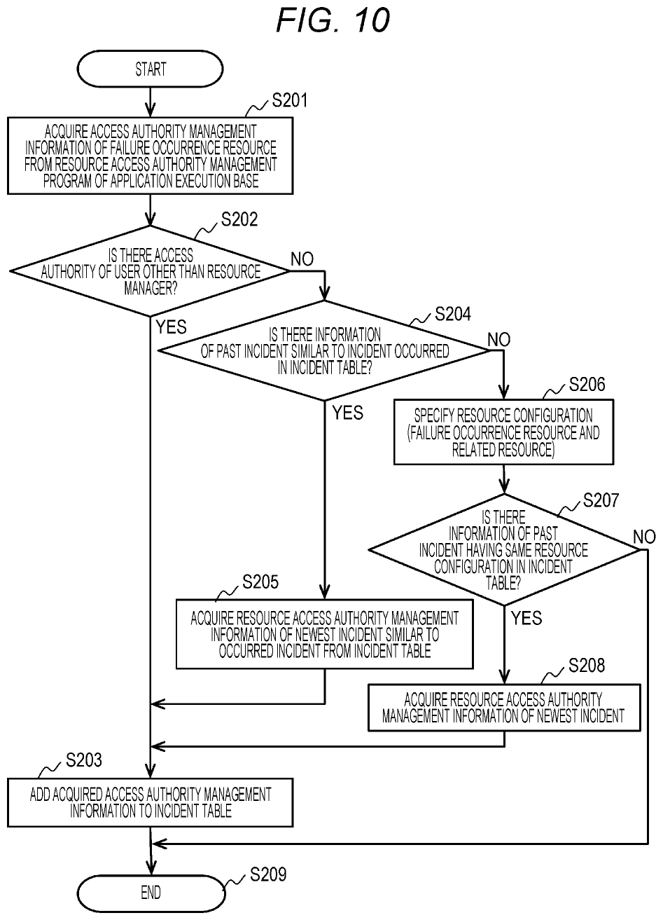

FIG. 10 is a flowchart for explaining an example of access authority management information acquisition processing. The access authority management information acquisition processing is a process of acquiring information on a failure occurrence resource from the access authority management information 119 of the application execution base 110 and registering an access authority to the failure occurrence resource in the incident table 313. The access authority management information acquisition processing is started, for example, when the incident information addition processing is completed. The access authority management information acquisition processing may be repeatedly executed a plurality of times.

The incident management program 310 acquires information (hereinafter, referred to as failure occurrence resource information) on the failure and the access authority in the failure occurrence resource from the access authority management information 119 of the application execution base 110. Specifically, the incident management program 310 calls the resource access authority management program 113 to acquire a portion (for example, the user ID of the user or the resource manager registered to be in charge of the failure occurrence resource and the access authority thereof) related to the failure occurrence resource from the access authority management information 119 (S201).

The incident management program 310 confirms whether the information of the access authority of the user other than the resource manager of the failure occurrence resource is included in the failure occurrence resource information acquired in S201 (S202).

When the information of the access authority of the user other than the resource manager of the failure occurrence resource is included (S202: Yes), the incident management program 310 executes the processing of S203, and when the information of the access authority of the user other than the resource manager of the failure occurrence resource is not included (S202: No), the incident management program 310 executes the processing of S204.

In S203, the incident management program 310 adds information of the access authority to the incident table 313. For example, the incident management program 310 adds the failure occurrence resource information (for example, the user ID of each user, the resource ID of the failure occurrence resource, and the information of the access authority) related to the user other than the resource manager specified in S202 to the resource access authority setting information 3137 of the record related to the failure occurrence resource in the incident table 313. Thus, the access authority management information acquisition processing ends (S209).

On the other hand, in S204, the incident management program 310 searches the incident table 313 for past incidents of the same type as the incidents related to the failure occurrence resource. For example, the incident management program 310 searches for a record in which the content of the application execution base ID 3133 and the content of the resource ID 3134 of the incident table 313 are the same as the application execution base ID and the resource ID of the failure occurrence resource, respectively, and the content of the incident ID 3131 of the incident table 313 or the content of the log information indicated by the log ID 3132 is the same or similar (also, the determination of similarity may be performed by, for example, a well-known technique for determining similarity of a character string or a word).

In a case where there is a past incident of the same type as the incident related to the failure occurrence resource (S204: Yes), the incident management program 310 executes the processing of S205, and in a case where there is no past incident of the same type as the incident related to the failure occurrence resource (S204: No), the incident management program 310 executes the processing of S206.

In S205, the incident management program 310 specifies the latest incident among the incidents searched in S204 and acquires the access authority information of the incident. Then, the incident management program 310 adds the information to the incident table 313 (S203). Thus, the access authority management information acquisition processing ends (S209).

For example, the incident management program 310 specifies the latest record among the records of the incident table 313 searched in S204, and acquires the content of the resource access authority setting information 3137 of the specified record (S205). The incident management program 310 sets the content of the acquired resource access authority setting information 3137 in the resource access authority setting information 3137 of the record related to the failure occurrence resource in the incident table 313 (S203).

On the other hand, in S206, the incident management program 310 detects the resource (hereinafter, referred to as related resources) related to the failure occurrence resource, and specifies the feature of the configuration of the resource group including the failure occurrence resource and the related resource.

Specifically, the incident management program 310 specifies the feature of the resource configuration on the basis of the reference and referenced relationship between the resources and the environment information of each resource. For example, first, the incident management program 310 specifies (1) the image name of the container (for example, Pod) of the failure occurrence resource, (2) the name of environment information (for example, Secret, ConfigMap) for accessing the container, and (3) all the image names of the containers of the resources (related resources) to which the environment information is referred. Then, the incident management program 310 specifies, for example, the number, type, name, similarity of data contents, and the like of the environment information and the related resources as the features of the resource configuration (the determination of similarity may also be performed by, for example, a well-known technique for determining similarity of a character string or a word).

The method of specifying the features (related resources and environment information) of the resource configuration is not limited to the above method. For example, the incident management program 310 may create data defining features of configurations of resources and environmental information in advance. The incident management program 310 may acquire the log information from the log ID 3132 of each record of the incident table 313 and analyze the acquired log information. The incident management program 310 may specify the feature by calling a predetermined management program included in the application execution server 100.

The incident management program 310 searches the incident table 313 for another resource group having a resource configuration having the same feature as the feature of the resource configuration specified in S206, and searches for a resource corresponding to the failure occurrence resource in the resource group (S207).

For example, the incident management program 310 searches all resource groups having the same relationship and the same environment information as a referencing or referenced relationship and the environment information of the resource specified in S206, and specifies the resource corresponding to the failure occurrence resource in each of the searched resource groups. Then, the incident management program 310 searches all the records of the incident table 313 in which the information of the specified resource is set. The incident management program 310 may search for a resource group having not only the same referencing or referenced relationship and the same environment information but also a referencing or referenced relationship and environment information having a certain similarity relationship.

When the resource cannot be searched in S207 (S207: No), the access authority management information acquisition processing ends (S209).

On the other hand, when the resource can be searched in S207 (S207: Yes), the incident management program 310 executes the processing of S208 and S203.

For example, the incident management program 310 acquires the content of the resource access authority setting information 3137 of the record searched in S206 (S208). The incident management program 310 sets the content of the acquired resource access authority setting information 3137 in the resource access authority setting information 3137 of the record related to the failure occurrence resource in the incident table 313 (S203). Thus, the access authority management information acquisition processing ends (S209).

<Incident Information Update Processing>

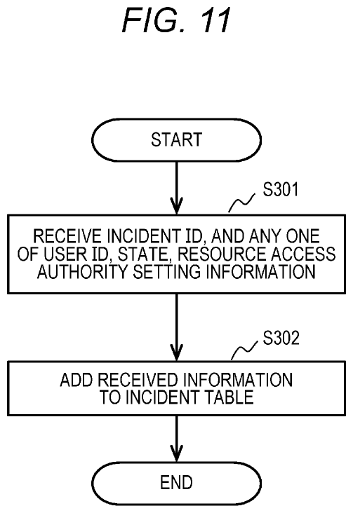

FIG. 11 is a flowchart for explaining an example of the incident information update processing. The incident information update processing is a process of correcting or updating the record content of the incident table 313 on the basis of the input from the resource manager. The incident information update processing is repeatedly executed after the creation of the incident table 313, for example.

The incident management program 310 of the incident management server 300 waits for reception, from the manager terminal 501, of the user ID of the failure handling user (determined by the resource manager or the like), the state information of the failure handling user (for example, “in process” or “completed”), or the information of the access authority of the failure handling user, to which the incident ID is attached (S301). The incident management program 310 may directly receive the input of these pieces of information from the resource manager or the like.

When the information is received (or input) (S301), the incident management program 310 updates the incident table 313 based on the received information (S302).

For example, the incident management program 310 specifies a record of the incident table 313 to be updated on the basis of the incident ID attached to the information received in S301. The incident management program 310 updates the user ID 3136, the state 3135, or the resource access authority setting information 3137 of the specified record with the information received in S301. Then, the incident information update processing ends.

<Access Authority Management Information Update Processing>

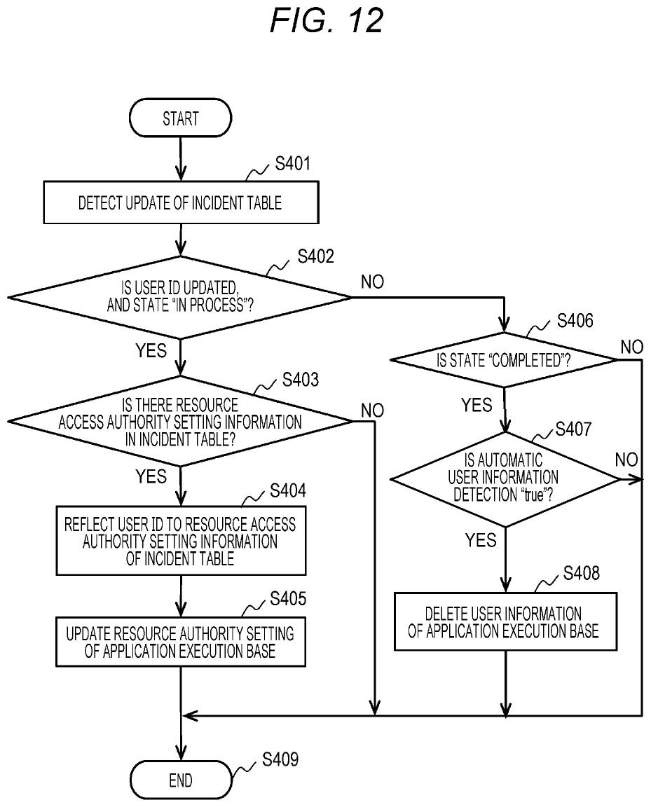

FIG. 12 is a flowchart for explaining an example of access authority management information update processing. The access authority management information update processing is a process of updating the access authority management information 119 of the application execution base 110 in response to the update of the incident table 313.

The incident management program 310 of the incident management server 300 monitors the update of the record of the incident table 313 at a predetermined timing (for example, a predetermined time interval (every 10 seconds) and a predetermined time) (S401). The update of the record of the incident table 313 is performed by, for example, the incident information addition processing, the access authority management information acquisition processing, or the incident information update processing.

When detecting the update of the incident table 313, the incident management program 310 specifies the update content.

The incident management program 310 determines whether the updated content is the start of recovery by the failure handling user (S402). For example, the incident management program 310 determines whether there is a record of the incident table 313 in which the information of the user (information of the failure handling user) has already been set or changed in the user ID 3136 and the state 3135 has been changed from “new” to “in process”.

In a case where the update content is the start of recovery by the failure handling user (S402: Yes), the incident management program 310 executes the processing of S403, and in a case where the update content is not the start of recovery by the failure handling user (S402: No), the incident management program 310 executes the processing of S406.

In S403, the incident management program 310 determines whether the access authority to the failure occurrence resource of the failure handling user is set. For example, the incident management program 310 determines whether the resource access authority setting information 3137 of the record specified in S402 includes the user ID of the failure handling user specified during the processing of S402.

When the access authority to the resource of the failure handling user is set (S403: Yes), the incident management program 310 executes the processing of S404, and when the access authority to the resource of the failure handling user is not set (S403: No), the access authority management information update processing ends (S409).

In S404, the incident management program 310 updates the access authority information of the incident table 313. For example, the incident management program 310 sets the portion of the user ID of the failure handling user in the access authority information set in the resource access authority setting information 3137 of the record specified in S402 to the content of the user ID 3136 of the record.

Then, the incident management program 310 transmits a setting request for requesting setting of the update content in S404 to the application execution base 110 (S405), and the access authority management information update processing ends (S409).

For example, the incident management program 310 transmits a setting request including the contents (information such as ID, resource, and access authority of the failure handling user) of the resource access authority setting information 3137 updated in S404 to the application execution base 110. In this case, the incident management program 310 specifies the end point on the basis of the information of the application execution base ID 3133 of the record and the application execution base table 311, and calls the specified end point to transmit the setting request.

Then, the resource access authority management program 113 of the application execution base 110 sets the content of the resource access authority setting information 3137 in the received setting request in the access authority management information 119.

On the other hand, in S406, the incident management program 310 determines whether the update content of the incident table 313 is the completion of the recovery by the failure handling user (S402). For example, the incident management program 310 determines whether there is a record in the incident table 313 of which the state 3135 has been changed from “in process” to “completed”.

When the update content of the incident table 313 is the completion of the recovery by the failure handling user (S406: Yes), the incident management program 310 executes the processing of S407, and when the update content of the incident table 313 is not the completion of the recovery by the failure handling user (S406: No), the access authority management information update processing ends (S409).

In S407, the incident management program 310 determines whether to delete the information of the failure handling user who has performed the recovery from the application execution base 110 (the access authority management information 119). For example, the incident management program 310 acquires the content of the application execution base ID 3133 of the record specified in S406, and confirms whether the automatic user information deletion 3113 of the record in which the acquired content is set in the application execution base ID 3131 in the application execution base table 311 is “true” or “false”.

When the information of the failure handling user who has performed the recovery is deleted, the incident management program 310 executes the processing of S408 (S407: Yes), and when the information of the failure handling user who has performed the recovery is not deleted (S407: No), the access authority management information update processing ends (S409).

In S408, the incident management program 310 transmits a request for deleting the information of the failure handling user who has performed the recovery in the access authority management information 119 to the application execution base 110 (S405), and the access authority management information update processing ends (S409).

For example, the incident management program 310 transmits a deletion request including information of the ID of the failure handling user set in the user ID 3136 of the record specified in S406 to the application execution base 110. In this case, the incident management program 310 specifies the end point from the application execution base table 311 on the basis of the information of the application execution base ID 3133 of the record, and calls the specified end point to transmit the deletion request.

Thereafter, the resource access authority management program 113 of the application execution base 110 deletes a portion of the access authority management information 119 corresponding to the received deletion request.

(Incident Management Screen)

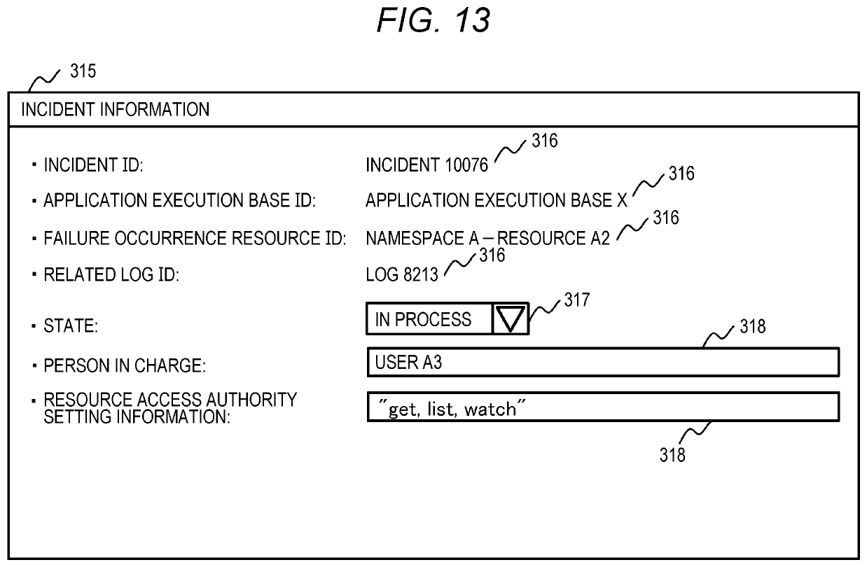

FIG. 13 is a diagram illustrating an example of the incident management screen 315. The incident management screen 315 includes display fields 316 of an incident ID, an application execution base ID, an ID of a failure occurrence resource, and a value of a log ID of the failure occurrence resource. The incident management screen 315 includes a setting field 317 that receives a setting of the state information (“new”, “in process”, “completed”) from the user. Further, the incident management screen 315 includes an input field 318 that receives an input of a person in charge and resource access authority setting information from the user.

As described above, the incident management server 300 of the present embodiment receives the failure information of the resource 115 from the application execution server 100 (the application execution base 110) in which the access to each resource 115 is managed on the basis of the access authority management information 119 via the application monitoring server 200, specifies the failure handling user who accesses the resource 115 in which the failure has occurred and the access authority of the failure handling user, and sets the information of the specified failure handling user and the information of the access authority in the access authority management information 119.

As a result, the information of the failure handling user in charge of recovery of the failure (incident) occurring in the resource 115 of the application execution base 110 and the access authority necessary for the recovery work can be reflected in the access authority management information 119 of the application execution base 110. As a result, the failure handling user can access the resource 115 of the application execution base 110 in which the failure has occurred and recover from the failure.

For example, even in a case where the failure handling user registered in the access authority management information 119 of the application execution base 110 is changed in the middle, the information of the appropriate failure handling user and the information of the access authority can be reflected in the access authority management information 119 when the failure is recovered.

As described above, according to the incident management server 300 of the present embodiment, it is possible to set an appropriate access authority necessary for recovery of the failure of the resource in which a failure has occurred. Then, it is possible to reduce the management cost of the access authority for coping with the failure of the resource.

Further, the incident management server 300 of the present embodiment determines whether the failure has been resolved, and deletes the information of the failure handling user set in the access authority management information 119 when determining that the failure has been resolved.

As a result, it is possible to prevent the resource 115 from being erroneously modified by the failure handling user although the failure has been resolved and the resource correction becomes unnecessary.

The incident management server 300 of the present embodiment specifies the information of the access authority on the basis of the failure information received from the application execution server 100 (the application monitoring server 200).

As a result, it is possible to specify information of an appropriate access authority based on the specification and operation of the application execution server 100 (the application execution base 110).

The incident management server 300 of the present embodiment specifies a failure corresponding to the occurred failure on the basis of failure information received in the past from the application execution server 100 (the application monitoring server 200), and specifies information of the access authority on the basis of information of the specified failure.

As a result, the information of the appropriate access authority can be specified on the basis of the past failure history of the application execution server 100 (the application execution base 110).

The incident management server 300 of the present embodiment specifies the relationship (the feature of the resource configuration) between the failure occurrence resource and the related resource, specifies the resource corresponding to the failure occurrence resource in the resource group having the same type of relationship as the specified relationship, and specifies the information of the access authority based on the specified resource and the failure information received in the past.

As a result, even in a case where the failure has not occurred in the failure occurrence resource in the past, it is possible to specify an appropriate access authority on the basis of another resource having a resource configuration similar to that of the failure occurrence resource.

The incident management server 300 of the present embodiment displays a screen for accepting an input of information of the user who accesses the failure occurrence resource from the resource manager, thereby specifying the failure handling user.

As a result, an appropriate failure handling user can be set on the basis of the determination of the resource manager.

The present invention is not limited to the above embodiments, and can be implemented using arbitrary components without departing from the gist of the present invention. The above-described embodiment and modifications are described as merely exemplary. The present invention is not limited to the contents as long as the features of the present invention are not damaged. Various embodiments and modifications have been described, but the present invention is not limited to these contents. Other aspects which are conceivable within a scope of technical ideas of the present invention may be made within the scope of the present invention.

For example, a part of each function included in each apparatus of the present embodiment may be provided in another apparatus, or a function included in another apparatus may be provided in the same apparatus.

What is claimed is:

1. An incident management apparatus that has a processor and a memory, comprising:
a failure information receiving unit configured to receive, from a server device that stores a plurality of resources and manages access to each resource based on access authority management information that is information including information of a user who can access each of the resources, information of a failure that has occurred in any of the plurality of resources;
an access authority information specifying unit configured to specify a user who accesses a resource in which the failure has occurred in the server device and an access authority of the user when information of the failure is received; and
an access authority management information setting unit configured to set information of the specified user and access authority in the access authority management information.

2. The incident management apparatus according to claim 1, wherein
the access authority management information setting unit determines whether the failure has been resolved, and deletes the information of the user set in the access authority management information when determining that the failure has been resolved.

3. The incident management apparatus according to claim 1, wherein
the access authority information specifying unit specifies the information of the access authority based on the information of the failure received from the server device.

4. The incident management apparatus according to claim 1, wherein
the access authority information specifying unit specifies a failure corresponding to the occurred failure based on failure information received in a past, and specifies the information of the access authority based on specified failure information.

5. The incident management apparatus according to claim 1, wherein
the access authority management information setting unit specifies a relationship between a resource in which the failure has occurred and another resource associated with the resource, specifies a resource corresponding to the resource in which the failure has occurred in a resource group having the same relationship as the specified relationship, and specifies information of the access authority based on the specified resource and information of the failure received in the past.

6. The incident management apparatus according to claim 1, wherein
the access authority information specifying unit specifies information of the user by displaying a screen that receives an input of information of a user who accesses a resource in which the failure has occurred.

7. An incident management method for causing an information processing device to execute:
failure information receiving processing of receiving, from a server device that stores a plurality of resources and manages access to each resource based on access authority management information that is information including information of a user who can access each of the resources, information of a failure that has occurred in any of the plurality of resources;
access authority information specifying processing of specifying a user who accesses a resource in which the failure has occurred in the server device and an access authority of the user when information of the failure is received; and
access authority management information setting processing of setting information of the specified user and access authority in the access authority management information.

8. The incident management method according to claim 7, wherein
in the access authority management information setting processing, the information processing device determines whether the failure has been resolved, and deletes the information of the user set in the access authority management information when determining that the failure has been resolved.

9. The incident management method according to claim 7, wherein
in the access authority information specifying processing, the information processing device specifies information of the access authority based on failure information received from the server device.

10. The incident management method according to claim 7, wherein
in the access authority information specifying processing, the information processing device specifies a failure corresponding to the occurred failure based on failure information received in a past, and specifies the information of the access authority based on specified failure information.

11. The incident management method according to claim 7, wherein
in the access authority management information setting processing, the information processing device specifies a relationship between a resource in which the failure has occurred and another resource associated with the resource, specifies a resource corresponding to the resource in which the failure has occurred in a resource group having the same relationship as the specified relationship, and specifies information of the access authority based on the specified resource and information of the failure received in the past.

12. The incident management method according to claim 7, wherein
in the access authority information specifying processing, the information processing device specifies information of the user by displaying a screen that receives an input of information of a user who accesses a resource in which the failure has occurred.
